(19) United States
(12) Patent Application Publication
(10) Pub. No.: US 2015/0375115 A1
(43) Pub. Date: Dec. 31, 2015

(54) INTERACTING WITH A STORY THROUGH PHYSICAL PIECES

(71) Applicant: Microsoft Corporation, Redmond, WA (US)

(72) Inventors: Alexandra Keeley Bunting, London (GB); James William Scott, Cambridge (GB); Nicolas Villar, Cambridge (GB); Haiyan Zhang, London (GB)

(21) Appl. No.: 14/319,628

(22) Filed: Jun. 30, 2014

(51) Int. Cl. A63F 13/47; A63F 13/235

(52) U.S. Cl. CPC A63F 13/47; A63F 13/235

(57) ABSTRACT

Methods of interacting with a story in a virtual world through manipulation of physical play pieces are described. An interactive software experience presents an interactive story to a user where the direction (and/or progression) of the story depends on user actions with physical play pieces. In an embodiment these actions are sensed by the physical play pieces themselves and sensed input data is communicated to the interactive software experience from the play pieces. The interactive story comprises one or more branching points at which there are a number of possible outcomes and one of the possible outcomes is selected at a branching point based on the sensed input data. The interactive story is presented to the user, for example using sounds and/or images.

### BACKGROUND

There are many ways that a user can interact with software and typically a user controls software via a keyboard and mouse or touch screen and for computer games, a user may use a games controller (which may be handheld or detect body movement). The user input device used is dependent upon the platform on which the game is being played (e.g. computer, games console or handheld device). A number of computer games have been developed in which gameplay is enabled (or unlocked) through the use of physical character toys which are placed on a custom base connected via a USB lead to a games console. By placing different toys on the custom base, different gameplay is enabled.

The embodiments described below are not limited to implementations which solve any or all of the disadvantages of known interactive software experiences and apparatus for interacting with interactive software experiences.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Methods of interacting with a story in a virtual world through manipulation of physical play pieces are described. An interactive software experience presents an interactive story to a user where the direction (and/or progression) of the story depends on user actions with physical play pieces. In an embodiment these actions are sensed by the physical play pieces themselves and sensed input data is communicated to the interactive software experience from the play pieces. The interactive story comprises one or more branching points at which there are a number of possible outcomes and one of the possible outcomes is selected at a branching point based on the sensed input data. The interactive story is presented to the user, for example using sounds and/or images.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows schematic diagrams of two example play systems;

FIG. 2 shows a first representation of an interactive story comprising a plurality of pre-defined branching points;

FIG. 3 shows a second representation of an interactive story comprising a plurality of pre-defined branching points;

FIG. 4 is a flow diagram of an example method of operation of an interactive software experience which comprises an interactive story

FIG. 5 is a schematic diagram of an example active piece and a flow diagram showing an example method of operation of an active piece;

FIG. 6 is a schematic diagram of another example active piece which incorporates the interactive story;

FIG. 7 is a schematic diagram of two example modules which may be connected together to form a physical play piece; and

FIG. 8 illustrates an exemplary computing-based device in which embodiments of the methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

An interactive software experience is described below which comprises an interactive story (e.g. an interactive adventure). The interactive story comprises one or more pre-defined branching points, i.e. points in the story where the story line can take one of a number of different paths, and both the position of the branching points along the story line and the possible outcomes (i.e. the different paths) may be pre-defined. The term ‘interactive story’ is used herein to refer to an interactive software experience which provides limited user interaction at pre-defined branching points and in between the branching points provides segments of audio and/or images (e.g. video or still images) where there is no user interaction (e.g. where the user hears and/or views the story). An interactive story is different from a computer game which allows (and requires) much more interaction and does not provide a limited number of interaction points (the pre-defined branching points).

The software receives sensed inputs which correspond to a user's action(s) with a physical play piece (which may also be referred to as a game piece), such as lifting up the piece or moving a part of the play piece (e.g. where the play piece has movable limbs). At a pre-defined branching point (and in various examples, at each pre-defined branching point), the received sensed inputs are used to determine the path that is taken (i.e. to select a path from the possible paths at the pre-defined branching point). At a branching point, only one of the possible paths going forward can be selected and therefore can be taken; although in some examples more than one branching point may occur at the same time (e.g. a branching point relating to the action of a first character and a branching point associated with a second character), with one outcome being taken from each branching point and the combination of outcomes defining the subsequent direction of the interactive story. The story is presented to the user (e.g. using sound and/or images) via a computing device which may be separate from the physical play pieces or integrated into one of the physical play pieces.

For example, in an interactive story about a battle between two knights, a user may have a play piece that represents the first knight and a play piece that represents a second knight. At a pre-defined branching point in the interactive story, the winner of a battle may be determined based on which knight the user is currently (or was most recently) holding, manipulating, or otherwise interacting with (as detected based on received sensed input data) and the story may progress based on this determination. For example, the knight which is lying down (e.g. horizontal) may be the loser and the knight which remains upright (e.g. vertical) is the winner. In various examples, a weapon that is held by the winning knight (e.g. a toy weapon) may be represented visually in the continuation of the story (to maintain continuity between the physical play and the interactive story.

As the inputs to the interactive story are by way of user actions with a physical play piece, the play piece and system offers a new user input device and method. Such devices/methods make it easier for a user to interact with the interactive software and may be particularly suited to less dexterous users (e.g. younger users and more elderly users) who may find use of a mouse/keyboard/games controller difficult to manipulate/control. Furthermore, through use of a combination of an interactive story and physical play pieces (which may be shaped to represent characters, objects or environments in the interactive story) the overall user experience is enhanced with the resulting experience being in both the virtual world and the real world.

As the direction taken by the interactive story (and hence the progression of the story) is dependent upon user actions (with a physical play piece), when a user plays the same interactive story again the outcome of the story is likely to be different. This increases the re-usability of the interactive story (e.g. compared to television programs where the outcome within an episode is always the same).

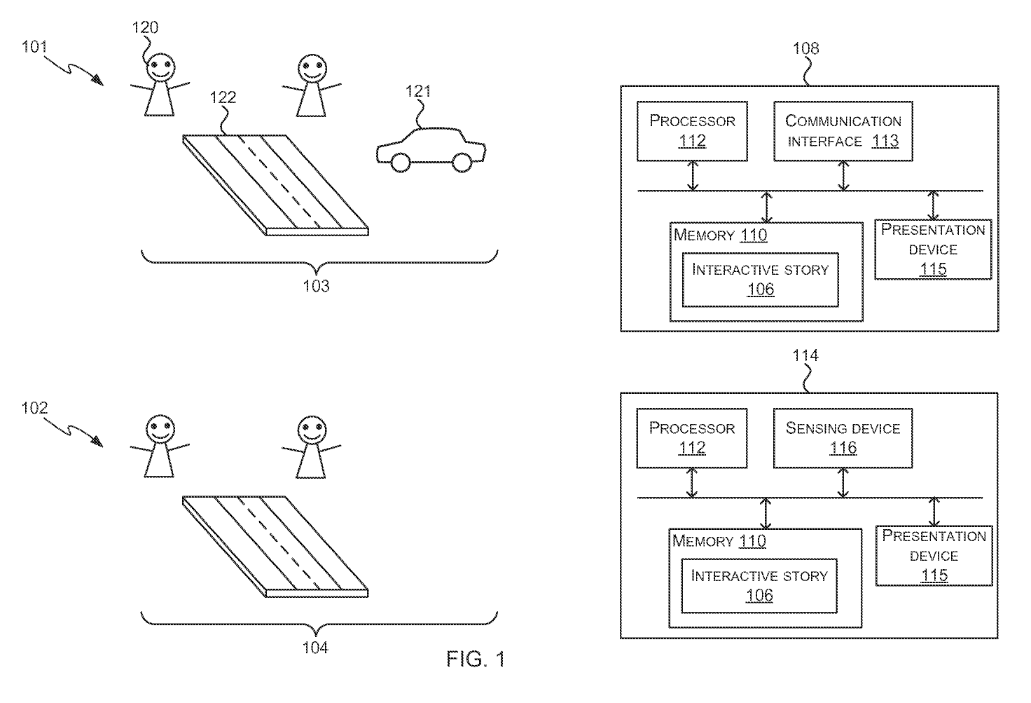

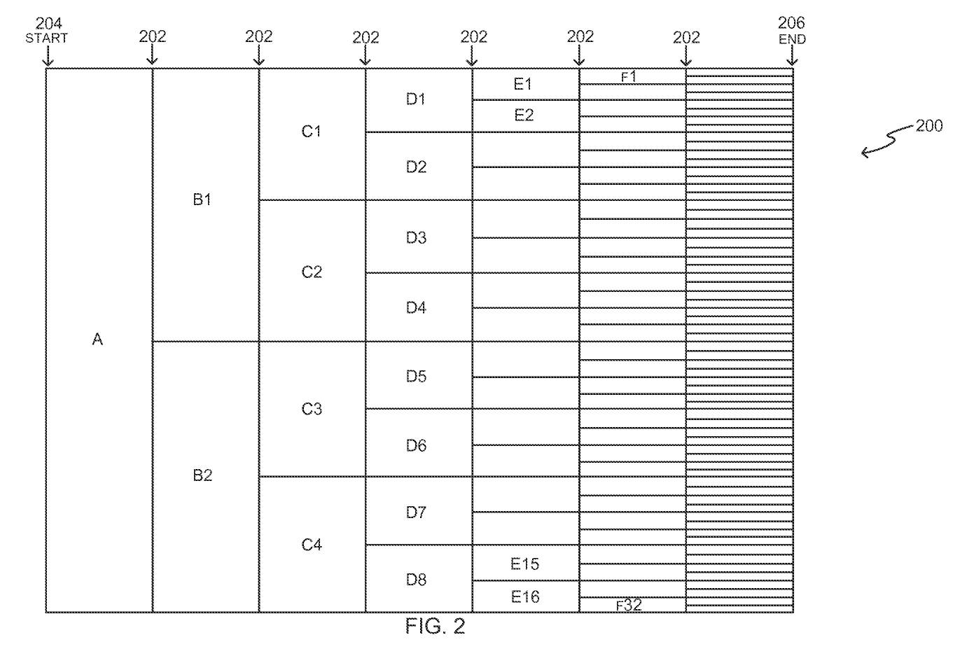

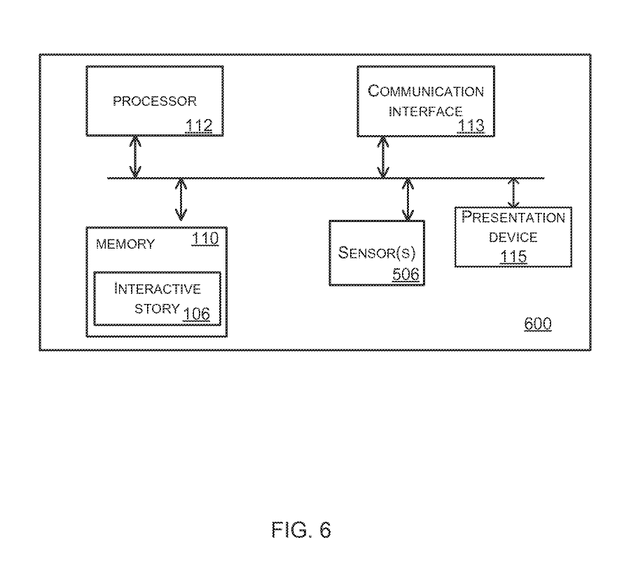

FIG. 1 shows schematic diagrams of two example play systems 101-102 which each comprise a set of physical play pieces 103-104 and an interactive software experience which comprises an interactive story 106. The interactive story 106 has at least one pre-defined branching point within the story and these branching points are described in more detail below with reference to FIG. 2. In both example play systems 101-102, the interactive story 106 uses a sensed input corresponding to a user's action with one or more of the physical play pieces 103-104 to determine the outcome at a branching point (i.e. which branch is selected) and so the interactive story 106 (and hence the interactive software experience) may be described as being associated with the set of physical play pieces 103-104. As is described in more detail below, the interactive story is presented to the user using sound, images and/or other effects (e.g. 2D or 3D video sequences, sound effects, haptic feedback, smell, etc.) by a computing device 108, 114 on which the interactive software experience runs. In various examples, the computing device may be integrated within one of the physical play pieces, as shown in FIG. 6.

The individual physical play pieces which form the set 103-104 may be shaped to represent a character, object or environment within the interactive story 106, such that the play piece looks the same as (or similar to) the corresponding entity in the interactive story (where this is presented in graphical form to the user). FIG. 1 shows play sets 103-104 which comprise two character play pieces 120, one vehicle play piece 121 and one base piece 122 which represents an environment within the interactive story. Whilst the base piece 122 is shown as being flat in FIG. 1, it will be appreciated that the base piece may alternatively not be flat (e.g. it may have contours or other features to more closely resemble different environments). In various examples a play piece may have movable parts (e.g. limbs which move relative to a body of a figurine) and/or be modular (i.e. formed from two or more modules connected together). In other examples, the physical play pieces may not be shaped to look like objects, characters, etc. but instead may all be of a similar shape.

In various examples, the physical play pieces may be arranged to act both as physical play pieces and beads which fit onto a connecting element (e.g. to form a bracelet, necklace or other fashion or wearable item). Such play pieces may comprise a hole through the piece to enable them to be threaded onto the connecting element or other means (e.g. a clip) to attach them onto the connecting element.

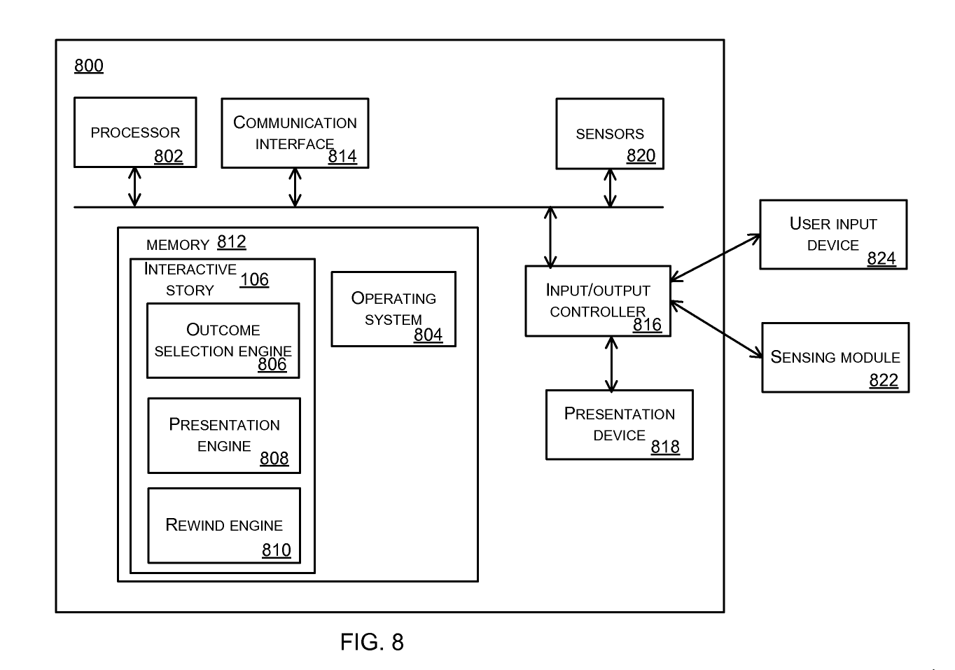

In the first example play system 101 shown in FIG. 1, the physical play pieces 103 are active pieces in that each piece actively communicates with other pieces and/or the associated interactive story 106 to provide information about the user's actions with the play pieces (i.e. the sensing is done within the pieces). The associated interactive story 106 runs on a computing device 108 which may be a desktop, laptop or tablet computer, a games console, a smart phone or any other computing device and in various examples computing device 108 may be a handheld computing device. In other examples, however, the computing device 108 may be integrated into one of the play pieces 103 and this is described in more detail with reference to FIG. 6. In the example system 101 shown in FIG. 1, the interactive story 106 is stored in memory 110 in the computing device 108 and comprises device-executable instructions which are executed by a processor 112. The interactive story 106 receives data from the active pieces 103 via a communication interface 113 in the computing device 108 and presents the interactive story to the user via a presentation device 115 (e.g. a display and/or speakers). It will be appreciated that the computing device 108 may also comprise additional elements and the computing device 108 is described in more detail below with reference to FIG. 8.

In the second example play system 102 shown in FIG. 1, the physical play pieces 104 are passive in that they do not actively communicate with each other or with the associated interactive story. In the example system 102 shown in FIG. 1, the interactive story 106 is stored in memory 110 in a computing device 114 and comprises device-executable instructions which are executed by a processor 112. Instead of receiving communications from one or more pieces (as in example 101), the interactive story 106 senses the motion of the pieces (when held by a user) using a sensing device 116 in the computing device 114 on which the interactive story runs and presents the interactive story to the user via a presentation device 115 (e.g. a display and/or speakers). As described above, the computing device 114 may be a desktop, laptop or tablet computer, a games console, a smart phone or any other computing device and in various examples computing device 114 may be a handheld computing device. It will be appreciated that the computing device 108 may also comprise additional elements and the computing device 114 is described in more detail below with reference to FIG. 8. The sensing device 116 may, for example, be a camera and image recognition/analysis system. Although the sensing device 116 is shown as part of the computing device 114, in other examples it may be part of a peripheral device connected to the computing device 114. In various examples, the sensing device 116 may be a Microsoft® Kinect®.

In a further example play system, the set of physical play pieces may comprise one or more active pieces and one or more passive pieces. In such an example, the active play pieces may detect their own motion and communicate with the interactive story and the motion of the passive pieces may be sensed by the sensing device 116 within the computing device or by a sensing device in a proximate active piece (which then communicates the sensed action to the interactive story 106).

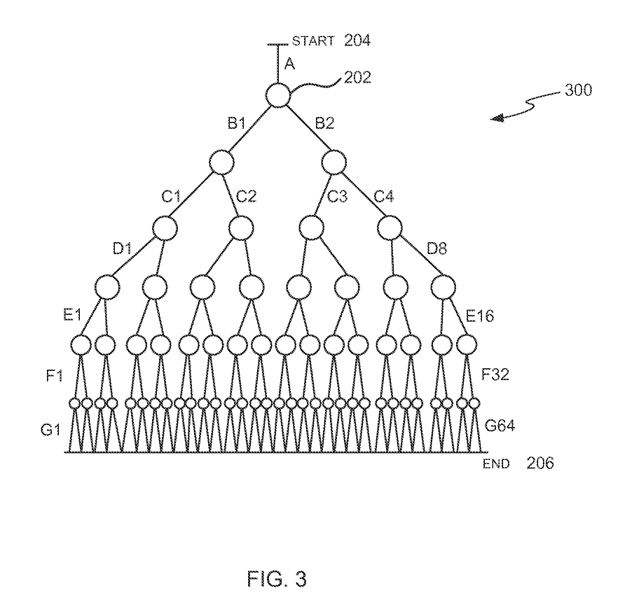

FIGS. 2 and 3 show two different representations 200, 300 of an interactive story comprising a plurality of pre-defined branching points 202, such as the interactive story 106 shown in FIG. 1. Like all stories in books and films, the interactive story has a pre-defined start point 204 and a pre-defined end point 206 (or multiple alternative end points) and in various examples, the length of the story (in terms of the time taken to present the story to the user) is preset (i.e. set before the start of the story). The preset value may be fixed (e.g. 10 minutes) or may be a user-selectable value (e.g. a user may select from story lengths of 10, 20 or 30 minutes). The story shown in FIGS. 2 and 3 starts with an initial story segment A prior to the first branching point 202. At the first branching point (and at every other branching point in the example shown) there are two possible forward paths, although in other examples there may be more than two possible forward paths at any branching point 202. In various examples there is a pre-defined and finite number of outcomes at each branching point; however in some examples an outcome may have associated parameters (e.g. which are also determined based on the sensed inputs) where a parameter value may be selected from a continuous spectrum of values (which may be limited to a range of values, e.g. 1-10,000) or from a discrete set of candidate values. In the example shown, following on from story segment A is either story segment B1 or story segment B2 and which segment (and hence path) is selected by the interactive story depends upon one or more sensed inputs that are received, where a sensed input corresponds to a user action with a physical play piece. These sensed inputs and user actions are described below.

In the story shown in FIGS. 2 and 3, the next branching point 202 (which is after story segment B1 or B2) leads to two further possible paths and the possible paths are dependent upon the previous path selection (i.e. at the previous branching point). For example, following story segment B1, the possible paths are story segments C1 and C2 and following story segment B2, the possible paths are story segments C3 and C4. Similarly, following segment C1 the possible paths are D1 or D2, for C2 they are D3 or D4, etc. In the example shown, each segment can only be reached by one path (e.g. to get to F1 the only path that can be followed is A-B1-C1-D1-E1-F1); however in other examples, the structure of the interactive story may be different such that there are a number of different paths that a user may take to reach the same segment (e.g. representation 300 may be more of a mesh than a tree arrangement).

Although the first representation 200 in FIG. 2 shows segments of equal length (in time), this is by way of example only and different segments may have different lengths, although as described above, in various examples the interactive story may have a fixed (or user-specified) length (in time), such that irrespective of the path traversed (as a consequence of the sensed inputs), the interactive story lasts for the same amount of time.

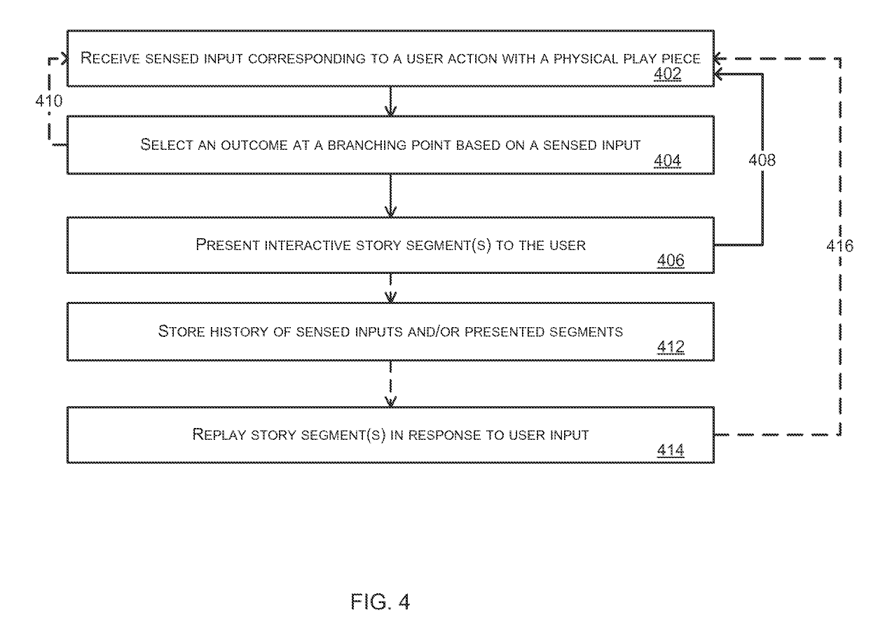

FIG. 4 is a flow diagram of an example method of operation of an interactive software experience which comprises an interactive story, where the interactive story comprises one or more pre-defined branching points. As shown in FIG. 4, the interactive software experience receives a sensed input corresponding to a user action with a physical play piece (block 402, e.g. via communication interface 113 or from sensing device 116) and selects an outcome at a pre-defined branching point in an interactive story based on a single sensed input or a combination or series of sensed inputs (block 404). An interactive story segment is subsequently presented to the user (block 406, e.g. using presentation device 115). In those examples where the length of the story is preset, the length of the story is determined prior to presentation of any of the story to the user, i.e. prior to presentation of the first segment of the story (in block 406).

In a first implementation, the method proceeds as indicated by arrow 408 with the next segment of the interactive story being presented to a user following the selection of the outcome from a pre-defined branching point. For example, referring back to FIG. 2, segment A is initially presented, then at the end of segment A, either segment B1 or segment B2 is selected (in block 404) based on a sensed input and then presented (in block 406). At the end of segment B1/B2, one of segments C1-C4 is selected and presented based on the previous segment presented (e.g. B1/B2) and based on a sensed input, where this sensed input may have been received (in block 402) subsequent to the previous branching point (e.g. whilst segment B1/B2 was being presented). Similarly, at the end of segment C1/C2/C3/C4, one of segments D1-D8 is selected and presented based on the previous segment presented (e.g. C1/C2/C3/C4) and based on a sensed input, where this sensed input may have been received whilst segment C1/C2/C3/C4 was being presented.

In a second implementation, the method proceeds as indicated by dotted arrow 410. In this second implementation all the sensed inputs are received (in block 402) and outcomes determined (in block 404) prior to presenting any of the interactive story segments to the user (in block 406). In the second implementation, the story may be influenced by another game or activity that was played previously. In the second implementation, there may be a time delay and/or location change between the receiving of the sensed inputs (in block 402) and the presenting of the interactive story segments (in block 406). In various examples, the audience may also change—for example two children may play together and the sensed inputs may be received and then they may subsequently watch the interactive story themselves and also share it with a relative or friend who is remote from them (e.g. living in another house, town, country, etc.).

Further implementations may comprise a combination of the first and second implementations described above, with some of the outcomes being determined (in block 404) before starting to present the interactive story segments (as in the second implementation) and other outcomes being determined later (as in the first implementation).

In various examples, if no suitable input is received (e.g. no input is received or none of the inputs corresponds to any of the available outcomes) to enable selection of an outcome (in block 404), an outcome may be selected automatically. The automatically selected outcome may be chosen in any way, including for example a fixed (default) outcome, a random outcome, or a cyclical selection of one of the available outcomes (cycling over the course of subsequent executions of the interactive story).

Where the first implementation is used (in its entirety or in part), there is more user engagement during the interactive story playback than where the second implementation is used. Depending upon the type of interactive story, this may result in the first implementation being more educational. For example, a user may be asked a question at a pre-defined branching point and then depending upon their reaction (e.g. during a pause), an outcome may be selected. This enables the user to engage with the portions of story (e.g. video) that they are watching.

The segments of the interactive story which are presented to the user may comprise sound and/or images, i.e. audio and/or visual effects, and in various examples other effects such as haptic feedback, smells, etc. For example, a segment may be an audio clip or a video clip (which may include a sound track or may be silent). In various examples the segments comprise pre-recorded (or pre-created) audio/video clips and in such examples a user may not be able to interact with the interactive story except at the pre-defined branching points 202. In other examples, however, the segments may not be pre-recorded but may be generated dynamically (e.g. dependent upon the particular play pieces within a user's play set) and again a user may not be able to interact with the interactive story except at the pre-defined branching points. In various examples, although a segment may not be pre-recorded/pre-created, it may be generated based on a pre-defined story section (e.g. a pre-defined description of what happens in the segment) and a characteristic of one or more play pieces, where the characteristic may be pre-defined (e.g. an environment which corresponds to a base play piece 122 or a character which corresponds to a figurine play piece 120) or linked to an external source (e.g. the user, a real world place, a TV show, etc. as described in more detail below). In such examples, a user may also not be able to interact with the interactive story except at the pre-defined branching points.

When making a selection (in block 404) based on a sensed input, the selection may be made based on inputs sensed (or sensed inputs received) during presentation of the previous segment (e.g. as described above with reference to the first implementation example) or based on sensed inputs which were received prior to presenting any of the story to the user (e.g. as described above with reference to the second implementation example). In various examples, the interactive story may store some or all of the sensed inputs (block 412) such that future interactive stories presented to the user are based, in part, on sensed inputs from previous interactive stories. This enables stories to develop over a period of time based on a longer history of user behavior (e.g. in the form of user actions with play pieces).

In addition to or instead of storing sensed inputs for use in future stories (as described above), sensed inputs or presented segments for a story may be stored (in block 412) to enable an interactive story to be replayed subsequently in response to a user input (block 414). When replaying an interactive story (in block 414) there may be no user interaction with the story (i.e. any sensed inputs received would not affect the interactive story which is being replayed). This replay feature may, for example, enable a user to rewind through a story and replay a part again. In various examples, a user may be able to rewind through a story to a previous branching point and then start to interact with the story once more (as indicated by dotted arrow 416). In such an example, a user may be able to explore different possible outcomes for an interactive story (e.g. by interacting differently with the play pieces, subsequent selections in block 404 may be different from the original story).

Although FIG. 4 shows segment selection (in block 404) based on sensed inputs, it will be appreciated that in various examples a user may also interact with the interactive story using another user input device (e.g. a mouse, keyboard or touch screen device). This interaction may, for example, be at times other than at the pre-defined branching points or may be used to detect the outcomes at a subset of the pre-defined branching points (in combination with or independent of any sensed inputs that correspond to a user action with a physical play piece). In various examples, a sensed input corresponding to a user action with a physical play piece (received in block 402) may be used to select an outcome (in block 404) at one or more pre-defined branching points in the interactive story.

As described above, the physical play pieces (e.g. in sets 103-104 shown in FIG. 1) may represent characters, objects or environments in the interactive story and various examples are shown in FIG. 1. Consequently, although the branching points 202 may be pre-defined in terms of their position along the story line, the particular segment choices (e.g. the possible outcomes at any branching point) may also depend on the particular play pieces being used by the user, e.g. the play pieces within the set 103-104. For example, in an interactive story there may be a total of 9 pre-defined outcomes from a branching point (e.g. 9 pre-created segments or 9 pre-created story sections); however, the when selecting an outcome (in block 404), the set of candidate outcomes (from which a selection is made in block 404) may not comprise all 9 outcomes but instead may comprise a subset of those 9 outcomes. In this example, the set of candidate outcomes may be selected from all possible outcomes based on the play pieces being used by the user (e.g. where this may be defined in terms of pieces with which a user has interacted at any point in the story, in the last hour, that day, etc.).

In an example, groups of three possible outcomes may each relate to a different environment (e.g. three ‘castle’ outcomes, three ‘beach’ outcomes, three ‘snowy’ outcomes) and the candidate outcomes may be restricted to those which correspond to an environment piece used by the user (e.g. castle landscape, beach landscape and/or snowy landscape). In this way, the selection of an outcome (in block 404) may be described as being dependent upon both a sensed input and one or more play pieces being used by the user. For example, if a user has interacted with the ‘castle’ base piece most recently of all base pieces (i.e. all available pieces that correspond to an environment), the candidate set of outcomes from which a selection is made (in block 404) comprises the three ‘castle’ outcomes.

In various examples, as described above, a user may be able to change the story by both interacting with play pieces which are characters and objects (e.g. moving them around) and assembling an environment from one or more environment (or base) play pieces.

In various examples, a physical play piece may be linked to a real world person or environment. For example, a play piece may be linked to the user or to a real world place. In various examples, the subset of candidate outcomes (from which a selection is made in block 404) may be limited based on a characteristic of the linked person/place. For example, based on the name of the person/place or the current weather at the place. In other examples, in addition to or instead of modifying the subset of candidate outcomes, the story itself (e.g. the segments of the interactive story) may be modified to reflect a characteristic of the linked person/place. For example, the interactive story may be modified to include a character with the same name as the user or a friend/relative of the user and/or the interactive story may be modified such that the weather reflects the current weather at the place (e.g. if it is raining at the user's location, it is raining in the interactive story). In various examples where a physical play piece is linked to a real world person, such as the user themselves, the user's real-world activity (e.g. their activity over a day/week/longer) may influence the interactive story (e.g. be used as a sensed input to the interactive story), e.g. eating healthily, exercising, attending an event or social gathering, clothing/fashion choices, etc.

In various examples even where a physical play piece is not linked to a real world place, the subset of candidate outcomes may be limited by a characteristic which mimics the real world. For example, the subset of candidate outcomes may be outcomes for a particular time of day/year (e.g. month, season) and the characteristic may change as the interactive story progresses to mimic the real world progression of time.

In various examples, a physical play piece may be linked to something other than a real world person or environment, such as to a fictional character/place in a television program. In such an example, the subset of candidate outcomes (from which a selection is made in block 404) may be limited based on a characteristic of the linked person/place. For example, based on the name of the fictional person/place or the weather at the fictional place in a recently broadcast episode. In other examples, in addition to or instead of modifying the subset of candidate outcomes, the story itself (e.g. the segments of the interactive story) may be modified to reflect a characteristic of the linked person/place (e.g. based on a recently broadcast episode of the television program). For example, the interactive story may be modified to include a character with the same name as the fictional character or another character in the same TV program and/or the interactive story may be modified such that the weather reflects the weather at the fictional place in a recently broadcast episode (e.g. if it was raining in the last broadcast episode, it is raining in the interactive story) or the weather at the location of the fictional character in a recently broadcast episode.

In the examples described above where a play piece is linked to an external source (e.g. the user, a real world place, a TV show, etc.) the segments used in presenting the interactive story (in block 406) may not be pre-created but instead may be created dynamically (in block 404 or following block 404) based on a pre-defined story section and a characteristic of the external source (e.g. a name, the weather, etc.). In such an example, an outcome may be selected (in block 404) from a set of candidate outcomes, where each candidate outcome corresponds to a pre-defined story section (e.g. an outline of what happens in a segment) and then the segment may be generated dynamically based on the selected section and the characteristic so that it can be presented to the user (in block 406).

As described above, the selection of a possible outcome (in block 404) is based on a sensed input (received in block 402), where the sensed input corresponds to a user action with a physical play piece. The user action may, for example, be:
Picking up, holding or touching a play piece;
Manipulating a play piece (e.g. where parts of the piece can be moved relative to other parts of the piece)—such as raising one leg of a play piece figurine;
Moving one or more pieces relative to each other (e.g. bringing two pieces into close proximity or touching two pieces together)—such as placing an object/character on a base piece or adding a new base piece to an existing arrangement of one or more base pieces; and/or
Moving (or gesturing with) a play piece.
   In various examples, the action may be a combination of any of these aspects or alternatively multiple aspects of an action may be independently sensed/reported (e.g. motion of piece A and motion of piece B may be independently sensed and communicated) to the interactive software experience and the selection (in block 404) may be based on multiple sensed inputs. In various examples, the user action may result in motion of a play piece (e.g. such that a sensed input corresponds to motion of a play piece) and in various examples, the user action may also include a user touching a play piece without additionally moving it.

In various examples, the sensed input may relate to one or more of:
The identity of a play piece (or multiple play pieces);
The proximity of a play piece to another play piece or to another object (e.g. a user, the computing device, a passive object representing scenery, etc.), e.g. the presence of a proximate play piece;
The motion or orientation of the play piece (or part of the play piece); and
The positions where a user is touching/holding the play piece or other aspects of user interaction (e.g. the pressure with which a user grips the play piece, which fingers a user is holding the piece with, etc.).

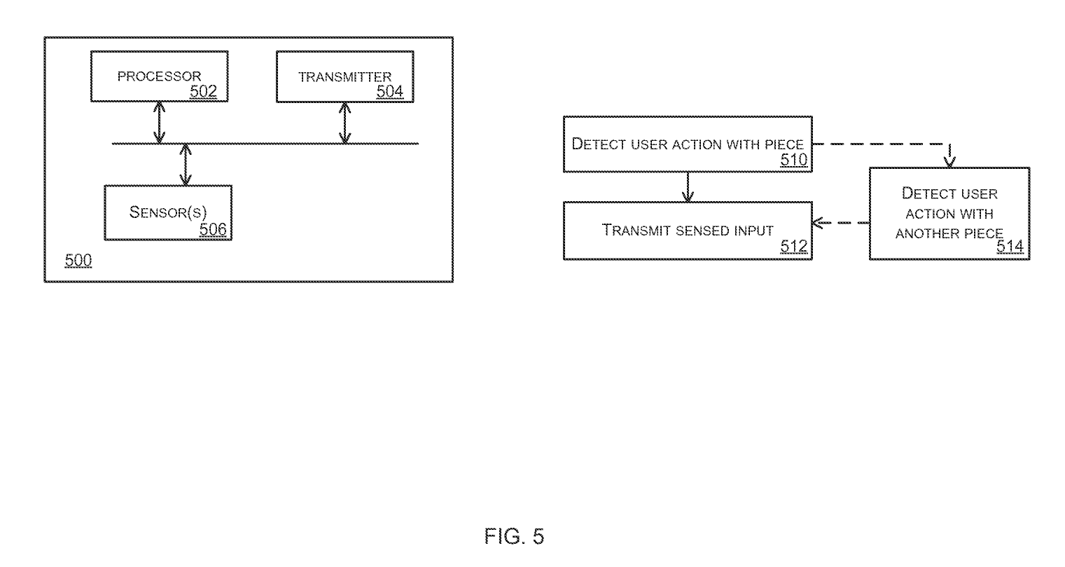

FIG. 5 is a schematic diagram of an example active piece 500 and a flow diagram showing an example method of operation of an active piece. The active piece 500 comprises a processor 502, transmitter 504 and one or more sensors 506 for detecting user actions, e.g. an accelerometer, pressure sensor, touch sensor (e.g. a capacitive sensor), light sensor, button, rotary sensor, force sensor, joystick, gyroscope, magnetometer, color sensor, depth sensor (e.g. using ultra-sound, infra-red intensity or time-of-flight, etc. As shown in the flow diagram, the piece detects a user action with the piece using the one or more sensors 506 (block 510) and then transmits data which describes the action (the sensed input) using the transmitter 504 (block 512) to the interactive story.

As described above, in some examples, a set of play pieces may also comprise one or more passive pieces and user actions with a passive piece may be sensed by the computing device running the interactive story or by a proximate play piece. In examples where the active piece 500 is configured to detect user actions with a proximate play piece, the active play piece may detect a user action with another play piece using the sensor(s) 506 (block 514) and transmit this data to the interactive story (in block 512).

The transmitter 504 in a play piece 500 may be a wireless device and may for example use Bluetooth® Low Energy (BLE) or other short range wireless protocol.

FIG. 6 is a schematic diagram of another example active piece 600 which incorporates the interactive story 106. This active piece 600 may be part of a set of physical play pieces where the other active pieces in the set are as shown in FIG. 5 and described above. The set may only comprise active pieces (e.g. one piece 600 and multiple pieces 500) or may also comprise one or more passive pieces. As shown in FIG. 6, the active piece comprises a processor 112, memory 110 which stores the interactive story 106, a communication interface 113, a presentation device 115 (e.g. a display and/or speakers) and one or more sensors 506. The operation of this active piece can be described with reference to FIGS. 4 and 5. The active piece 600 receives sensed input data from one or more other physical play pieces in the set (block 402) via the communication interface 113 and also detects user actions with itself (block 510) using the one or more sensors 506. In various examples, the active piece 600 may also detect user actions with a proximate passive piece (block 514) using the one or more sensors 506. Based on the detected actions (from blocks 510 and 514) and received sensed inputs (from block 402), the interactive story 106 selects an outcome at a pre-defined branching point in the story (block 404) and presents interactive story segments to the user (block 406) via the presentation device 115.

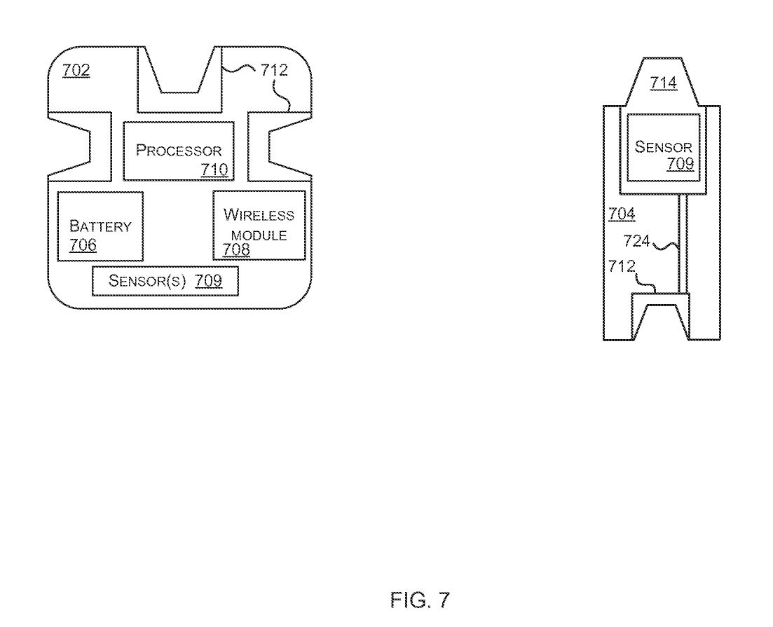

In various examples, the play pieces may themselves be modular and be formed from two or more modules. FIG. 7 is a schematic diagram of two example modules which may be connected together to form a physical play piece. FIG. 7 shows a core module 702 and a peripheral module 704. The core module 702 comprises a battery 706, a wireless communications module 708, a processor 710, one or more sensors 709 and one or more connectors 712. The battery 706 provides power to components within the core (such as processor 710 and wireless communications module 708) and also to some/all of the peripheral modules 704 via the connectors 712. The wireless communications module 708 enables the core module 702 to communicate with a computing device running the interactive story 106. Any suitable wireless technology may be used (e.g. Bluetooth®, BLE, WiFi™ or WiFi™ Direct, Near Field Communication (NFC), 802.15.4, etc.). The wireless communications module 708 may communicate directly with the computing device 108 (as shown in FIG. 1) running the interactive story 106 or may communicate via a network (e.g. a home network or the internet) or intermediary device (e.g. a wireless access point). The connectors 712 physically attach the peripheral modules 704 to the core module 702 and may also pass data and power between play pieces.

The processor 710 within the core play piece 702 is arranged to detect user actions using the sensor(s) 709. In various examples, the processor may also collect the IDs (which may be a unique ID or an ID shared with other identical-looking modules, e.g. an ID for a particular shape or type of module) of each of the modules connected together to form a coherent physical whole play piece. The processor 710 may be a microprocessor, controller or any other suitable type of processor for processing computer executable instructions to control the operation of the core play piece in order to detect user actions on the core module and in some examples also on connected peripheral modules (e.g. where a peripheral module does not comprise sensor(s) and/or a processor and wireless module. Core and peripheral modules may be connected together in any way.

In various examples, the processor 710 may also collect the IDs of connected modules. The module IDs may be collected from each of the connected modules directly (e.g. via a bus) or each module may collect information on its neighbors with the core module aggregating the data provided by its direct neighbor play pieces. In various examples, these module IDs may be collected via the data connection provided by the connectors 712 and in other examples, another means may be used (e.g. NFC, QR codes or computer vision). Where other means are used, the core module 702 may comprise additional hardware/software such as an NFC reader module or a camera or other image sensor to collect the module IDs of all the connected play pieces. In addition to collecting the module IDs of the connected module (e.g. to generate a set or list of connected modules), the core module may detect the topology of the arrangement of play pieces.

Each peripheral module 704 comprises one or more connectors 712, 714 to physically attach the module to another module to form a coherent physical whole play piece. The peripheral module 704 may also comprise one or more sensors 709 for detecting user actions. The peripheral module 704 may further comprises electrical connections 724 (e.g. in the form of a bus comprising 2 wires, data and ground) between the two connectors 712, 714. In the example shown in FIG. 7, the sensor 709 is shown within the housing of the connector 714; however, in other examples it may be separate from the connector.

Although not shown in FIG. 7, a peripheral module 704 may also comprises a storage element which stores an identifier (ID) for the peripheral module (which may be referred to as the module ID) and may comprise additional data, such as the shape and/or appearance of the play piece, locations of any connection points, etc. The storage element may comprise memory or any other form of storage device. In various examples, a peripheral module 704 may also comprise a processor (not shown in FIG. 7) and this may be within the housing of the connector 714 or separate from the connector. In various examples, a peripheral module 704 may also comprise a battery (not shown in FIG. 7) and this may provide power to electronics within the peripheral module 704 and/or to neighboring modules (which may be peripheral or core modules). In this way, if an arrangement of modules requires more power than can be provided by the battery 706 in the core module 702, additional power can be provided by a battery in a peripheral module 704.

Although not shown in FIG. 7, a core module 702 may also comprise a storage element which stores an identifier for the module. As with the peripheral module, the storage element may comprise memory or any other form of storage device. The storage element which stores the module ID may be within a connector 712, the wireless module 708 or may be a separate entity within the core module 702.

Examples of sensors 709 that may be used in modules include: temperature sensors, vibration sensors, accelerometers, tilt sensors, gyroscopic sensors, rotation sensors, magnetometers, proximity sensors (active/passive infrared or ultrasonic), sound sensors, light sensors, etc.

It will be appreciated that the modules 702, 704 shown in FIG. 7 may comprise additional elements not shown in FIG. 7. It will further be appreciated that although FIG. 7 shows the modules as being square or rectangular, each of the modules can have any physical form factor (e.g. any shape of external housing) which is compatible with the other modules (i.e. each module is shaped such that it can connect to at least one other module, without the outer housing clashing).

FIG. 8 illustrates various components of an exemplary computing-based device 800 which may be implemented as any form of a computing and/or electronic device, and in which embodiments of the methods described herein may be implemented. This computing based device 800 may, for example, be the computing device 108, 114 shown in FIG. 1 or an active play piece 500, 600 such as shown in FIGS. 5 and 6.

Computing-based device 800 comprises one or more processors 802 which may be microprocessors, controllers or any other suitable type of processors for processing computer executable instructions to control the operation of the device in order to perform the methods described herein (e.g. generate an interactive story by selecting paths at pre-defined branching points and present the story to the user). In some examples, for example where a system on a chip architecture is used, the processors 800 may include one or more fixed function blocks (also referred to as accelerators) which implement a part of the method of generating and presenting an interactive story in hardware (rather than software or firmware).

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs).

Platform software comprising an operating system 804 or any other suitable platform software may be provided at the computing-based device to enable application software, such as an interactive software experience comprising an interactive story 106 to be executed on the device. As shown in FIG. 8, the interactive story 106 may comprise one or more modules, such as an outcome selection engine 806 arranged to select an outcome at a branching point (e.g. as in block 404), a presentation engine 808 arranged to generate the sound/images to present segments of the story (e.g. as in block 406) and a rewind engine 810 to store sensed inputs/story segments and to allow a user to rewind the interactive story (e.g. as in blocks 412-414).

The computer executable instructions may be provided using any computer-readable media that is accessible by computing based device 800. Computer-readable media may include, for example, computer storage media such as memory 812 and communications media. Computer storage media, such as memory 812, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 812) is shown within the computing-based device 800 it will be appreciated that the storage may be distributed or located remotely and accessed via a network or other communication link (e.g. using communication interface 814).

The communication interface 814 may be arranged to receive data from one or more physical play pieces and may comprise a wireless receiver. In various examples the communication interface 814 receives data from the physical play pieces directly and in other examples, the communication interface 814 may receive data from the play pieces via an intermediary device.

In examples where the computing-based device 800 is integrated within a play piece (e.g. as shown in FIG. 6), the computing-based device 800 may comprise one or more sensors 820 arranged to detect an action of the play piece.

The computing-based device 800 may also comprise an input/output controller 816. The input/output controller may be arranged to output presentation information for use in presenting the interactive story to the user (e.g. in block 406) to a presentation device 818 (e.g. a display or speakers) which may be separate from or integral to the computing-based device 800. The input/output controller 816 may also be arranged to receive and process input from one or more devices, such as a sensing module 822 (which may be internal or external to the computing based device 800) or a user input device 824 (e.g. a mouse, keyboard, camera, microphone or other sensor). The sensing module 822 may, for example, be used to detect user actions with passive pieces (as described above). In some examples the user input device 824 may detect voice input, user gestures or other user actions and may provide a natural user interface (NUI). This user input may be used to further control the interactive story. In an embodiment the presentation device 818 may also act as the user input device 824 if it is a touch sensitive display device. The input/output controller 816 may also output data to devices other than the display device, e.g. a locally connected printing device (not shown in FIG. 8).

Any of the input/output controller 816, presentation device 818, sensing module 822 and the user input device 824 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

Although the present examples are described and illustrated herein as being implemented in a play system (comprising a set of physical play pieces and an associated interactive story) as shown in FIGS. 1 and 6, the systems described are provided as examples and not limitations. As those skilled in the art will appreciate, the present examples are suitable for application in a variety of different types of play systems.

An aspect provides a method comprising: receiving sensed input data corresponding to a user action with a physical play piece; selecting an outcome at a pre-defined branching point in an interactive story based on received sensed input data and presenting the interactive story to the user via a presentation device. In such examples, the interactive story comprises one or more pre-defined branching points and a pre-defined branching point has two or more possible outcomes from which the outcome is selected.

In various examples, presenting the interactive story to the user comprises: presenting an interactive story segment corresponding to the selected outcome to the user.

In various examples the interactive story segment is pre-created. The use of pre-created story segments reduces the processing power required to implement the method (as processing power is not required to generate the sound/images dynamically) and this may make it particularly suited to computing devices which are resource constrained (e.g. handheld computing devices or computing devices which are integrated within a physical play piece).

In other examples, the interactive story segment is generated based on a pre-defined story section corresponding to the selected outcome and a characteristic of a physical play piece. In various examples, the characteristic of a physical play piece comprises a link to an external data source and the method further comprises: accessing the external data source. This combines use of stored data (which reduces computational effort) with the ability to personalize the story for a user based on their personal characteristics (e.g. their friends, family, location, interests, favorite TV shows, etc.).

In examples where the interactive story segment is generated based at least in part on stored data (e.g. an entire stored segment or a stored story outline), a user may not be able to interact with the story except at the pre-defined branching points.

In various examples, the method may further comprise storing a history of sensed input data or presented interactive story segments; and in response to a user input, replaying a part of the interactive story to the user. This enables a user to rewind the story and play some or all of it again, with the replayed part being the same it was the first time that it was played (unlike if decisions were made afresh at each branching point). This is unlike a user's interaction with a computer game which is transitory and cannot easily be reviewed subsequently.

In various examples, the interactive story comprises a pre-defined start point and one or more pre-defined end points and has a duration which is fixed prior to presenting the interactive story to the user. This provides predictability to the user, which is unlike a typical computer game where the game may last a variable amount of time dependent upon how well the user plays the game.

In various examples, the user action comprises motion of the physical play piece.

Another aspect provides a system comprising a physical play piece, the active physical play piece comprising: a sensor operative to detect a user interaction with the physical play piece; and an output arranged to transmit data describing the detected user interaction to an associated interactive software experience, the associated interactive software experience comprising an interactive story and the interactive story comprising one or more pre-defined branching points.

In various examples, the sensor is operative to detect one or more of: a proximate physical play piece, an orientation of the physical play piece and a position where the user is touching the physical play piece.

In various examples, the output is a transmitter and the active physical play piece further comprises a sensor operative to detect a user interaction with a proximate physical play piece and wherein the wireless transmitter is further arranged to transmit data describing the detected user interaction with the proximate physical play piece to the associated interactive software experience.

In various examples, the active physical play piece has a shape and/or appearance which corresponds to a character, object or environment in the interactive story. This enhances the user experience by making the real world and the virtual world activities correspond more closely (i.e. the user motion of play pieces and the interactive story which is presented are more similar).

In various examples, the active physical play piece further comprises: a presentation device; and an outcome selection engine operative to select an outcome at a pre-defined branching point in the interactive story based on a detected user interaction; and a presentation engine operative to present the interactive story to the user via the presentation device. By integrating the computing-based device which presents the interactive story into a physical play piece, a separate computing-based device is not required. This may further enhance the user experience and make the experience more suited to younger users (e.g. children) who may not be able to operate a handheld or desktop computer or games console or who may not have access to such a device.

In various examples, the active physical play piece further comprises: a memory arranged to store a plurality of pre-created interactive story segments, each segment corresponding to a possible outcome at a pre-defined branching point in the interactive story.

A further aspect provides a computing-based device comprising: a processor; a presentation device; a memory comprising device-executable instructions which when executed cause the processor to: select an outcome at a pre-defined branching point in an interactive story based on received sensed input data, the received sensed input data corresponding to a user action with a physical play piece and the interactive story comprising one or more pre-defined branching points and a pre-defined branching point having two or more possible outcomes from which the outcome is selected; and present the interactive story to the user via the presentation device.

In various examples, the memory is further arranged to store a plurality of pre-created interactive story segments, each segment corresponding to a possible outcome at a pre-defined branching point in the interactive story. In such examples, presenting the interactive story to the user comprises: presenting a pre-created interactive story segment to the user, the pre-created interactive story segment corresponding to the selected outcome.

In various examples, the memory is further arranged to store a plurality of pre-defined interactive story sections, each section corresponding to a possible outcome at a pre-defined branching point in the interactive story. In such examples, presenting the interactive story to the user comprises: generating an interactive story segment based on a characteristic of a physical play piece and a pre-defined interactive story section corresponding to the selected outcome; and presenting the interactive story segment to the user.

In various examples, the characteristic of the physical play piece is linked to an external data source. In such examples, presenting the interactive story to the user further comprises accessing the external data source to obtain information which is used in generating the interactive story segment.

In various examples, the computing-based device further comprises a communication interface operative to receive sensed input data from a physical play piece.

In various examples, the computing-based device further comprises a sensing module operative to detect a user action with a physical play piece and generate the sensed input data. This enables the computing-based device to sense user actions with passive play pieces (e.g. play pieces which do not comprise sensors to detect when a user interacts with them).

Another aspect provides a system comprising a physical play piece, the active physical play piece comprising: a means for detecting a user interaction with the physical play piece; and a means for communicating data describing the detected user interaction to an associated interactive software experience, the associated interactive software experience comprising an interactive story and the interactive story comprising one or more pre-defined branching points.

A yet further aspect provides a computing-based device comprising: means for selecting an outcome at a pre-defined branching point in an interactive story based on received sensed input data and means for presenting the interactive story to the user via the presentation device. In such examples, the received sensed input data corresponds to a user action with a physical play piece and the interactive story comprises one or more pre-defined branching points and a pre-defined branching point has two or more possible outcomes from which the outcome is selected.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method comprising:
receiving sensed input data corresponding to a user action with a physical play piece;
selecting an outcome at a pre-defined branching point in an interactive story based on received sensed input data, the interactive story comprising one or more pre-defined branching points and a pre-defined branching point having two or more possible outcomes from which the outcome is selected; and
presenting the interactive story to the user via a presentation device.

2. The method according to claim 1, wherein presenting the interactive story to the user comprises:
presenting an interactive story segment corresponding to the selected outcome to the user.

3. The method according to claim 2, wherein the interactive story segment is pre-created.

4. The method according to claim 2, further comprising:
generating the interactive story segment based on a pre-defined story section corresponding to the selected outcome and a characteristic of a physical play piece.

5. The method according to claim 4, wherein the characteristic of a physical play piece comprises a link to an external data source and the method further comprises:
accessing the external data source.

6. A method according to claim 2, further comprising:
storing a history of sensed input data or presented interactive story segments; and
in response to a user input, replaying a part of the interactive story to the user.

7. A method according to claim 1, wherein the interactive story comprises a pre-defined start point and one or more pre-defined end points and has a duration which is fixed prior to presenting the interactive story to the user.

8. A method according to claim 1, wherein the user action comprises motion of the physical play piece.

9. A system comprising a physical play piece, the active physical play piece comprising:
a sensor operative to detect a user interaction with the physical play piece; and
an output arranged to transmit data describing the detected user interaction to an associated interactive software experience, the associated interactive software experience comprising an interactive story and the interactive story comprising one or more pre-defined branching points.

10. The system according to claim 9, wherein the sensor is operative to detect one or more of: a proximate physical play piece, an orientation of the physical play piece and a position where the user is touching the physical play piece.

11. The system according to claim 9, wherein the output is a transmitter, the active physical play piece further comprises a sensor operative to detect a user interaction with a proximate physical play piece and wherein the wireless transmitter is further arranged to transmit data describing the detected user interaction with the proximate physical play piece to the associated interactive software experience.

12. The system according to claim 9, wherein the active physical play piece has a shape which corresponds to a character, object or environment in the interactive story.

13. The system according to claim 9, wherein the active physical play piece further comprises:
a presentation device; and
an outcome selection engine operative to select an outcome at a pre-defined branching point in the interactive story based on a detected user interaction; and
a presentation engine operative to present the interactive story to the user via the presentation device.

14. The system according to claim 13, wherein the active physical play piece further comprises a memory arranged to store a plurality of pre-created interactive story segments, each segment corresponding to a possible outcome at a pre-defined branching point in the interactive story.

15. A computing-based device comprising:
a processor;
a presentation device;
a memory comprising device-executable instructions which when executed cause the processor to:
select an outcome at a pre-defined branching point in an interactive story based on received sensed input data, the received sensed input data corresponding to a user action with a physical play piece and the interactive story comprising one or more pre-defined branching points and a pre-defined branching point having two or more possible outcomes from which the outcome is selected; and
present the interactive story to the user via the presentation device.

16. The computing-based device according to claim 15, wherein the memory is further arranged to store a plurality of pre-created interactive story segments, each segment corresponding to a possible outcome at a pre-defined branching point in the interactive story and wherein presenting the interactive story to the user comprises:
presenting a pre-created interactive story segment to the user, the pre-created interactive story segment corresponding to the selected outcome.

17. The computing-based device according to claim 15, wherein the memory is further arranged to store a plurality of pre-defined interactive story sections, each section corresponding to a possible outcome at a pre-defined branching point in the interactive story and wherein presenting the interactive story to the user comprises:
generating an interactive story segment based on a characteristic of a physical play piece and a pre-defined interactive story section corresponding to the selected outcome; and
presenting the interactive story segment to the user.

18. The computing-based device according to claim 17, wherein the characteristic of the physical play piece is linked to an external data source.

19. The computing-based device according to claim 15, further comprising a communication interface operative to receive sensed input data from a physical play piece.

20. The computing-based device according to claim 15, further comprising a sensing module operative to detect a user action with a physical play piece and generate the sensed input data.
